(19) United States
(12) Patent Application Publication
(10) Pub. No.: US 2005/0099808 A1
(43) Pub. Date: May 12, 2005

(54) Light-emitting device

(76) Inventors: Tzu Chi Cheng, Taipei (TW); June Pin Cheng, Taipei (TW); Kun-Chui Lee, Taipei (TW)

Correspondence Address: TZU CHI CHENG, 235 CHUNG-HO BOX 8-24, TAIPEI HSIEN, 235, TW

(21) Appl. No.: 10/705,508

(22) Filed: Nov. 12, 2003

(51) Int. Cl. F21V 9/00

(52) U.S. Cl. 362/231

(57) ABSTRACT

A light-emitting device comprises at least one blue light emitting diode as a blue light source; at least one red light emitting diode as a red light source; and a fluorescent layer formed by mixing fluorescent powders with transparent resin; the fluorescent layer being glued to the blue light emitting diode and the red light emitting diode; the blue light emitting diode and the red light emitting diode emitting lights of different colors which are then mixed; the blue light being used to excite the fluorescent layer to emit light with wavelengths different from the blue light and red light. In another structure, a fluorescent layer is formed by mixing fluorescent powders with transparent resin; and the fluorescent layer encloses the blue light emitting diode. A transparent resin layer encloses the fluorescent layer and red light emitting diode.

### FIELD OF THE INVENTION

The present invention relates to light-emitting devices, and particular to a light-emitting device having at least two light-emitting semiconductors containing a blue light emitting diode and a red light emitting diode for emitting lights to stimulating green or yellow fluorescent layers so that the fluorescent layer emits light with wavelength different from those of the blue light and red light.

### BACKGROUND OF THE INVENTION

In one prior art light-emitting device, a blue light emitting diode is used to excite a yellow fluorescent layer so as to generate white light of different wavelength. Since only single color light is mixed to blue light, the color rendering index is not good, namely, the white light generator is not as pure as desired.

In another prior art, an ultraviolet light emitting diode is used as a light source to excite red light, green light and blue light fluorescent layers so as to generate white light. However, the ultraviolet light will destroy general used epoxy resin so as to decay the white light. Especially since only one emitting diode is used as a light source, the strength of the excited white light is insufficient.

### SUMMARY OF THE INVENTION

Accordingly, the primary object of the present invention is to provide a light-emitting device having at least two light-emitting diodes containing blue light emitting diode and red light emitting diode for emitting blue light and red light to excite green or yellow fluorescent layers so that the fluorescent layer emits light with wavelength different from those of the blue light and red light. Thereby, a color (for example, white light) with preferred color rendering index and efficiency is acquired.

To achieve above objects, the present invention provides a light-emitting device which comprises at least one blue light emitting diode as a blue light source; at least one red light emitting diode as a red light source, and a fluorescent layer formed by mixing fluorescent powders with transparent resin; the fluorescent layer being glued to the blue light emitting diode and the red light emitting diode; the blue light emitting diode and the red light emitting diode emitting lights of different colors which are then mixed, the blue light being used to excite the fluorescent layer to emit light with wavelengths different from the blue light and red light. In another structure, a fluorescent layer is formed by mixing fluorescent powders with transparent resin; and the fluorescent layer encloses the blue light emitting diode. A transparent resin layer encloses the fluorescent layer and red light emitting diode.

The various objects and advantages of the present invention will be more readily understood from the following detailed description when read in conjunction with the appended drawing.

### BRIEF DESCRIPTION OF THE DRAWINGS

FIG. 1 is a first cross section view of the embodiment of the present invention.

FIG. 2 is a second cross section view of the embodiment of the present invention.

FIG. 3 is a third cross section view of the embodiment of the present invention.

FIG. 4 is a plane schematic view showing that blue light, red light, and green light are mixed to present white light.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

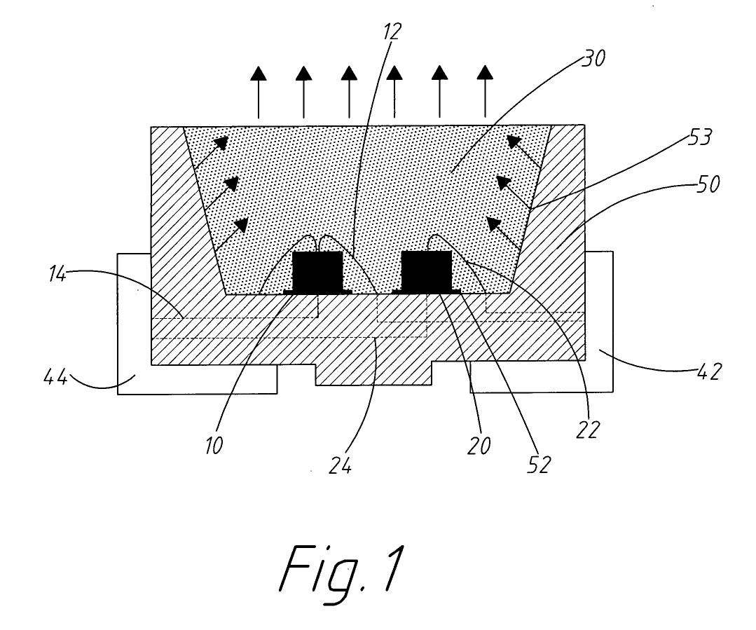

With reference to FIG. 1, the light-emitting device of the present invention is illustrated. The light-emitting device comprises the following elements.

At least one blue light emitting diode 10 is as a blue light source.

At least one red light emitting diode 20 is as a red light source.

A fluorescent layer 30 is formed by mixing fluorescent powders with transparent resin. The fluorescent layer 30 can be glued to the blue light emitting diode 10 and the red light emitting diode 20. The blue light emitting diode 10 and the red light emitting diode 20 emit lights of different colors which are then mixed. The fluorescent layer 30 absorbs radiation having a blue light to emit light with wavelengths different from the blue light and red light.

According to above mentioned features, the light emitted from the fluorescent layer 30 due to the excitation of the blue and red light is mixed with the red light and the blue light so as to present light which can be defined as white light.

In fact the wavelength of the light from the fluorescent layer 30 is between 500 and 585 nm.

In above mention feature, the blue light from the blue light emitting diode 10 has a wavelength between 360 and 480 nm and the red light from the red light emitting diode 20 is between 585 and 780 nm.

In above said feature, the fluorescent powders of the fluorescent layer 30 can be one of Yttrium Aluminium Garnet, and SmOn⁴⁻, and BxOy³⁻.

In above said features, the blue light emitting diode 10 and red light emitting diode 20 can be connected to a recess 52 in a reflecting cover 50. The fluorescent layer 30 can be filled in the recess 52.

From above mentioned features, the blue light emitting diode 10 and red light emitting diode 20 can be connected to the groove 62 above a main lead frame 60. The fluorescent layer 30 is filled in the groove 62.

In above mentioned features, material of the fluorescent powders of the fluorescent layer 30 may be selected from one of the follow group or the combination thereof. The group contains YAG (yttrium aluminum garnet) activated by cerium and containing Y (yttrium) and Al (Aluminum)—(YAG: Ce³⁺); YAG activated by europium—(YAG: Eu²⁺/Eu³⁺) and YAG activated by Terbium (YAG: Tb³⁺).

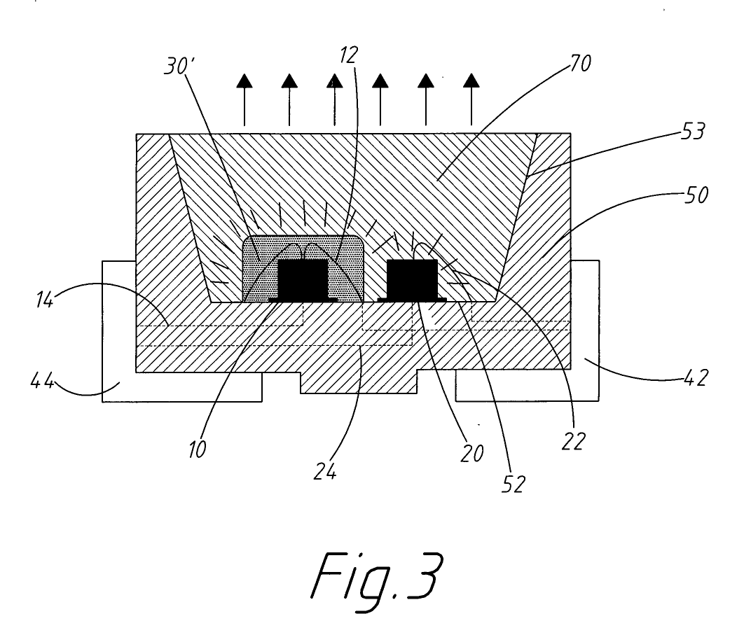

With reference to FIG. 3, another embodiment of the present invention is illustrated. The embodiment provides a light-emitting device. The light-emitting device includes the following features.

At least one blue light emitting diode 10 is as a blue light source.

At least one red light emitting diode 20 is as a red light source.

A fluorescent layer 30′ is formed by mixing fluorescent powders with transparent resin. The fluorescent layer 30′ encloses the blue light emitting diode 10.

A transparent resin layer 70 serves to enclose the fluorescent layer 30′ and red light emitting diode 20. The blue light is used to excite the fluorescent layer 30′ to emit light with wavelengths different from the blue light and red light. The light emits out from the transparent resin layer 70 so that the light from the fluorescent layer 30′ is mixed with blue light and red light to present light of another color.

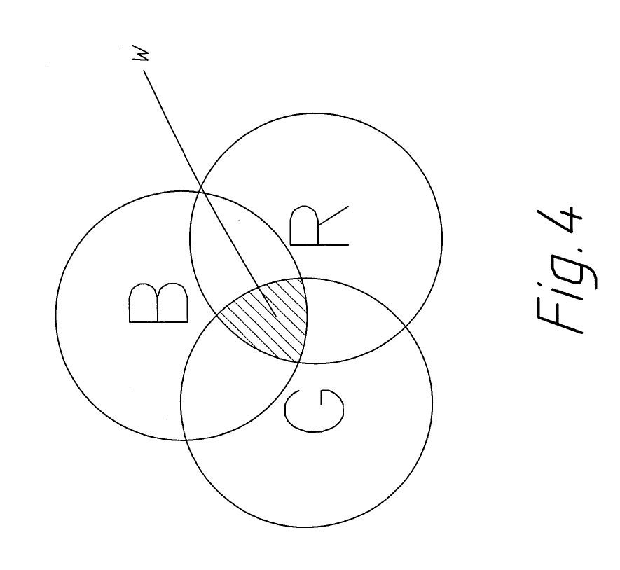

With reference to FIG. 1, the red light emitting diode 20 and blue light emitting diode 10 are connected to a recess 52 of a reflecting cover 50. The conductive pins 22, 24 of the red fight emitting diode 20 are connected to the two conductive frames 42, 44. The conductive pins 12, 14 of the blue light emitting diode 10 are connected to the two conductive frames 42, 44. The conductive frame 42 is electrically isolated to the conductive frame 44 so as to form an electric loop. The fluorescent powders of the fluorescent layer 30 are selected from one of YAG, silicate (SmOn4−), or borate (BxOy3−), that is to say the fluorescent powders can be selected from at least one of (YAG: Ce³⁺), (YAG: Eu²⁺/Eu³⁺), and (YAG: Tb3⁺) or the combination thereof. In fact, the wavelength of the light from the fluorescent layer 30 is between 500 and 585 nm which is green or yellow or a color between green and yellow. The light is emitted from the blue light emitting diode 10 and the light is emitted from the red light emitting diode 20. As shown in FIG. 4, the blue light B from the blue light emitting diode 10 has a wavelength between 360 and 480 nm and the red light R from the red light emitting diode 20 is between 585 and 780 nm.

When the red light and, blue light are mixed and then emitted out, the mixing light passes through the reflecting cover 50 (referring to FIG. 1), the light is reflected from the inner wall 53 so as to simulate the green or yellow fluorescent powders of fluorescent layer 30 to generate light with wavelength different from blue light B and red light R (i. e., green light G) which has a wavelength between 510 to 570 nm. The green light G is mixed with the blue light B and red light R so as to present white light W (referring to FIG. 4). Since the white light W is from the blue light B and red light R to excite the fluorescent powders to generate green light G so that the white light W is sparkle and is efficiently emitted.

With reference to FIG. 3, another embodiment of embodiment is illustrated. In the embodiment, the fluorescent layer 30′ encloses independently the blue light emitting diode 10. The transparent resin layer 70 further encloses the fluorescent layer 30′ and the red light emitting diode 20. Thereby, when the blue light emitting diode 10 emits blue light, the blue light will excite the fluorescent layer 30′ to emit another wavelength which is different from the blue light and red light. The light is mixed with blue light and red light so that the three lights are mixed. Thereby, the light from the mixing of the three colors emits from the transparent resin layer 70.

In the present invention, the currents to the blue light emitting diode 10 and red light emitting diode 20 are controlled so as to control the wavelengths of the blue light and the red light. For example, the red light R can be changed to have wavelength between orange color and red color. If the wavelength of the light emitted from the fluorescent layer 30 is 570 nm, when the fluorescent powders are excited by the blue light B and red light R, the fluorescent layer 30 will emit light with wavelength of 590 nm (for example, orange yellow light).

Thereby, to change the wavelengths of the lights from the blue light and red light, the light emitted from the fluorescent layer 30 is determinant.

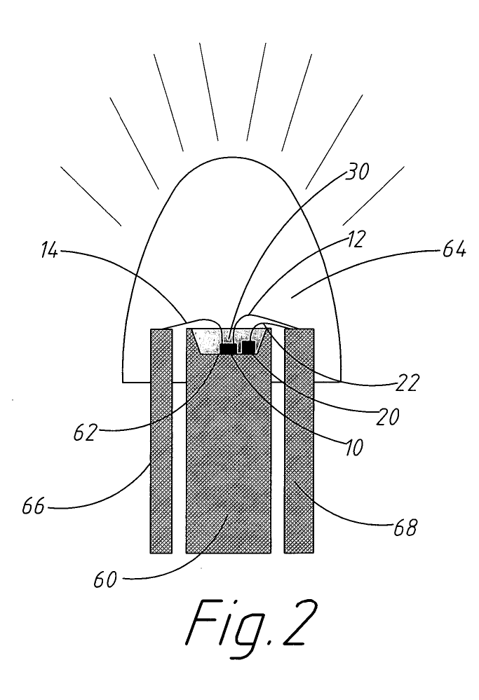

With reference to FIG. 2, in the present invention, the transparent resin 64 encloses the fluorescent layer 30 and the main lead frame 60, and the pins 22, 23 and 14 of the blue light emitting diode 10 and red light emitting diode 20 are connected to a lead frame 66 and a right lead frame 68 so as to form an electric loop.

The fluorescent layer 30 is excited by blue light and red light so as to emit light with wavelength different from the wavelengths of blue light and red light. The light is emitted from a transparent resin 64.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A light-emitting device comprising:
at least one blue light emitting diode as a blue light source;
at least one red light emitting diode as a red light source; and
a fluorescent layer formed by mixing fluorescent powders with transparent resin; the fluorescent layer being glued to the blue light emitting diode and the red light emitting diode; the blue light emitting diode and the red light emitting diode emitting blue light and red light, respectively, which are then mixed; the fluorescent layer absorbing radiation having a blue light to emit light with wavelengths different from the blue light and red light.

2. The light-emitting device as claimed in claim 1, wherein the light emitted from the fluorescent layer due to the excitation of the blue and red light is mixed with the red light and the blue light so as to present white light.

3. The light-emitting device as claimed in claim 1, wherein the wavelength of the light from the fluorescent layer is between 500 and 585 nm.

4. The light-emitting device as claimed in claim 1, wherein the blue light from the blue light emitting diode has a wavelength between 360 and 480 nm and the red light from the red light emitting diode is between 585 and 780 nm.

5. The light-emitting device as claimed in claim 1, wherein the fluorescent powders of the fluorescent layer 30 are selected from one of Yttrium Aluminium Garnet, and SmOn4−, and BxOy3−.

6. The light-emitting device as claimed in claim 1, wherein the blue light emitting diode and red light emitting diode are connected to a recess in a reflecting cover; the fluorescent layer is filled in the recess.

7. The light-emitting device as claimed in claim 1, wherein the blue light emitting diode and red light emitting diode are connected to a groove above a main lead frame; and the fluorescent layer is filled in the groove.

8. The light-emitting device as claimed in claim 1, wherein material of the fluorescent powders of the fluorescent layer is selected from one of a follow group containing YAG (yttrium aluminum garnet) activated by cerium and containing Y (yttrium) and Al (Aluminum) (YAG: Ce³⁺); YAG activated by europium (YAG: Eu²⁺/Eu³⁺); and YAG activated by Terbium (YAG: Tb3⁺) and the combination thereof.

9. A light-emitting device comprising:
at least one blue light emitting diode as a blue light source;
at least one red light emitting diode as a red light source;
a fluorescent layer formed by mixing fluorescent powders with transparent resin; and the fluorescent layer enclosing the blue light emitting diode; and
a transparent resin layer enclosing the fluorescent layer and red light emitting diode; the blue light emitted from the blue light emitting diode stimulating the fluorescent layer to emit light with wavelengths different from the blue light and red light; the light emitted from the transparent resin layer so that the light from the fluorescent layer is mixed with blue light and red light to present light of another color.
